(19) United States
(12) Patent Application Publication
(10) Pub. No.: US 2026/0290206 A1
(43) Pub. Date: Sep. 24, 2026

(54) SYNTHETIC CONNECTIVE TISSUE ADHERENT FOR DENTAL TRAINING MODELS AND DENTAL PROSTHESES

(71) Applicant: Michael Congiusta, Brooklyn, NY (US)

(72) Inventor: Michael Congiusta, Brooklyn, NY (US)

(21) Appl. No.: 19/083,028

(22) Filed: Mar. 18, 2025

(51) Int. Cl. G09B 23/28; C08F 122/38; C09J 135/00

(52) U.S. Cl. CPC G09B 23/286; C08F 122/385; C09J 135/00; G09B 23/283

(57) ABSTRACT

A dental training model including a viscoelastic adherent configured to produce a micromechanical bond between a tooth and a socket in a jaw of the dental training model, thereby simulating connective tissue, and one or more radiopaque elements disposed within the viscoelastic adherent. The viscoelastic adherent may simulate a tendon or a ligament. Further, the viscoelastic adherent may be formed of one or more of resin, epoxy, cyanoacrylate, silicone, polycarboxylate, glass ionomer, resin modified glass ionomer, elastomers, and/or hydrocolloids.

### FIELD

This present disclosure relates to a synthetic connective tissue adherent for dental training models and dental prostheses.

### BACKGROUND OF THE DISCLOSURE

The development of accurate dental training models presents a significant challenge due to the lack of materials that effectively simulate the biomechanical properties of ligaments or tendons. Traditional dental models often fail to provide the interactive and realistic experience necessary for comprehensive surgical training. This limitation can disadvantage users, such as surgeons, residents, interns, students, and nurses, when performing real-life surgeries, as they may not have had the opportunity to practice on models that mimic the tactile and mechanical properties of actual human or animal tissues.

Additionally, current training models often fail to exhibit radiographic signatures similar to those of dental elements in humans or animals. This discrepancy can hinder the ability to practice and interpret radiographic images accurately, further limiting the effectiveness of the training models.

What is needed is improved dental animal or human dental models that bridge the gap between traditional training methods and the demands of real-life surgery.

### SUMMARY OF THE DISCLOSURE

The present disclosure provides a viscoelastic adherent analogous to a ligament or tendon that may be used to enhance training models, such as dental training models, used by those learning soft and hard tissue handling and manipulation. In an embodiment, the present disclosure may relate to a composition of a viscoelastic adherent with properties like collagen in a ligament or a tendon, such as, but not limited to, elastic recovery, distortion, compressive and tensile strength, viscosity, elastic modulus, and retention and solubility.

In embodiments for the present disclosure, the viscoelastic adherent may include an addition cured silicone that includes setting inhibitors to promote a long working time and a short setting time. In embodiments, this may be dictated by the reaction between the terminal hydrogen and vinyl groups in the presence of a scavenging platinum catalyst.

In an embodiment, the viscoelastic adherent may resemble a putty. The viscoelastic adherent may include a base and a catalyst. Embodiments of the present disclosure may yield the most accurate of all impression materials, may have the least distortion, and show a high elastic recovery.

In an embodiment, the viscoelastic adherent may resemble a cyanoacrylate derivative. In this form, the viscoelastic adherent may be stored at room temperature and used for cohesion between two surfaces to promote micromechanical bonding. Variable copolymers may be combined and compatible with cyanoacrylate to further enable the interaction of anionic polymerization and to promote robust bonding. In an embodiment, the viscoelastic adherent may be stored at room temperature. The viscoelastic adherent may provide strong adherent and cohesive properties, making it durable amongst any surface, plastic, or texture, while retaining characteristics of the optimal bonding agent.

Embodiments of the present disclosure include the characteristics of collagen, without losing features upon setting times.

The present disclosure provides a dental training model including a viscoelastic adherent configured to produce a micromechanical bond between a tooth and a socket in a jaw of the dental training model, thereby simulating connective tissue and one or more radiopaque elements disposed within the viscoelastic adherent.

In an aspect of the present disclosure, the connective tissue simulated may include a tendon or a ligament.

In an aspect of the present disclosure, the viscoelastic adherent may include one or more of a resin, epoxy, cyanoacrylate, silicone, polycarboxylate, glass ionomer, resin modified glass ionomer, elastomers, and/or hydrocolloids.

In an aspect of the present disclosure, the viscoelastic adherent may include a first part comprising a cyanoacrylate derivative and a second part comprising a liquid configured to activate the cyanoacrylate derivative and initiate the micromechanical bond.

In an aspect of the present disclosure, the viscoelastic adherent may include a cyanoacrylate monomer derivative of methyl cyanoacrylate and one or more of the following: a copolymer, a silicone, and/or a resin.

In an aspect of the present disclosure, the viscoelastic adherent may include a free radical curable component formed of a cyanoacrylate compound.

In an aspect of the present disclosure, the tooth and/or the jaw may include one or more radiopaque elements.

In an aspect of the present disclosure, the one or more radiopaque elements of the tooth and/or the jaw may differ in radiodensity from the one or more radiopaque elements disposed within the viscoelastic adherent.

In an aspect of the present disclosure, the one or more radiopaque elements may include barium sulphate.

The present disclosure provides a synthetic connective tissue for use in a dental training model. In an embodiment, the synthetic connective tissue may include a viscoelastic adherent configured to create a micromechanical bond between a tooth and a socket in a jaw of the dental training model, thereby simulating connective tissue and one or more radiopaque elements disposed within the viscoelastic adherent.

In an aspect of the present disclosure, the connective tissue may include a tendon or a ligament.

In an aspect of the present disclosure, the viscoelastic adherent may include one or more of a resin, epoxy, cyanoacrylate, silicone, polycarboxylate, glass ionomer, resin modified glass ionomer, elastomers, and/or hydrocolloids.

In an aspect of the present disclosure, the viscoelastic adherent may include a first part including a cyanoacrylate derivative and a second part comprising a liquid configured to activate the cyanoacrylate derivative and initiate the micromechanical bond.

In an aspect of the present disclosure, the viscoelastic adherent may include a cyanoacrylate monomer derivative of methyl cyanoacrylate and one or more of the following: a copolymer, a silicone, and/or a resin.

In an aspect of the present disclosure, the viscoelastic adherent may include a free radical curable component formed of a cyanoacrylate compound.

The present disclosure provides a method of manufacturing a dental training model including providing a viscoelastic adherent with one or more radiopaque elements disposed within the viscoelastic adherent and disposing the viscoelastic adherent between a tooth and a socket in a jaw of the dental training model to produce a micromechanical bond, thereby simulating connective tissue.

In an aspect of the present disclosure, the viscoelastic adherent may include one or more of the following: a resin; epoxy; cyanoacrylate; silicone; polycarboxylate; glass ionomer; resin modified glass ionomer; elastomers; and/or hydrocolloids.

In an aspect of the present disclosure, the tooth and/or the jaw may include one or more radiopaque elements.

In an aspect of the present disclosure, the one or more radiopaque elements of the tooth and/or the jaw may differ in radiodensity from the one or more radiopaque elements disposed within the viscoelastic adherent.

### BRIEF DESCRIPTION OF THE FIGURES

For a fuller understanding of the nature and objects of the disclosure, reference should be made to the following detailed description taken in conjunction with the accompanying figures.

FIG. 1 depicts an embodiment of a dental training model as described herein.

FIGS. 2 and 3 are perspective views of an embodiment of the dental training model as described herein.

FIG. 4 is a perspective view of the maxilla of an embodiment of the dental training model.

FIG. 5 is a perspective view of the mandible of an embodiment of the dental training model.

FIG. 6 is a maxilla and mandible superior view of an embodiment of the dental training model.

FIG. 7 is a maxilla and mandible inferior view of an embodiment of the dental training model.

FIGS. 8 and 9 depict administration of X-rays to an embodiment of the dental training model.

FIGS. 10-19 are X-ray images of an embodiment of the dental training model.

FIGS. 20-25 are perspective views of an embodiment of the dental training model having various pathology.

FIG. 26 displays a table detailing the properties of an viscoelastic adherent used in embodiments of the dental training model. The properties of this viscoelastic adherent resembles collagen types 1 and 3, often found in ligaments, especially the periodontal ligament found between tooth and bone.

FIG. 27 displays a table demonstrating possible materials that may be used in the viscoelastic adherent having characteristics similar or dissimilar to the ideal material of the viscoelastic adherent used in embodiments of the dental training model.

FIG. 28 displays an illustration of two chemical structures found in an embodiment of the viscoelastic adherent as described in Example 1.

FIGS. 29A-29C display images that portray prior to tooth placement into an alveolar bone socket simulated a canine lower jaw (FIG. 29A), application of the viscoelastic adherent onto the tooth (FIG. 29B), and placement of the tooth into the alveolar bone socket (FIG. 29C), as described in Example 1.

FIGS. 30A-30B display dental insertion into the periodontal ligament for extraction of a molar tooth in a canine oral cavity, as described in Example 1.

FIGS. 31A-31B display radiographic images with illuminating radiopaque elements (bright white), depicted as the periodontal ligament, incorporated into the adherent, as described in Example 1.

### DETAILED DESCRIPTION OF THE DISCLOSURE

The present disclosure provides a dental training model including a viscoelastic adherent configured to produce a micromechanical bond between a tooth and a socket in a jaw of the dental training model, thereby simulating connective tissue, and one or more radiopaque elements disposed within the viscoelastic adherent.

The present disclosure further provides a synthetic connective tissue for use in a dental training model. In an embodiment, the synthetic connective tissue may include a viscoelastic adherent configured to create a micromechanical bond between a tooth and a socket in a jaw of the dental training model, thereby simulating connective tissue and one or more radiopaque elements disposed within the viscoelastic adherent.

The present disclosure even further provides a method of manufacturing a dental training model including providing a viscoelastic adherent with one or more radiopaque elements disposed within the viscoelastic adherent and disposing the viscoelastic adherent between a tooth and a socket in a jaw of the dental training model to produce a micromechanical bond, thereby simulating connective tissue.

In an aspect of the present disclosure, the connective tissue simulated may include a tendon or a ligament.

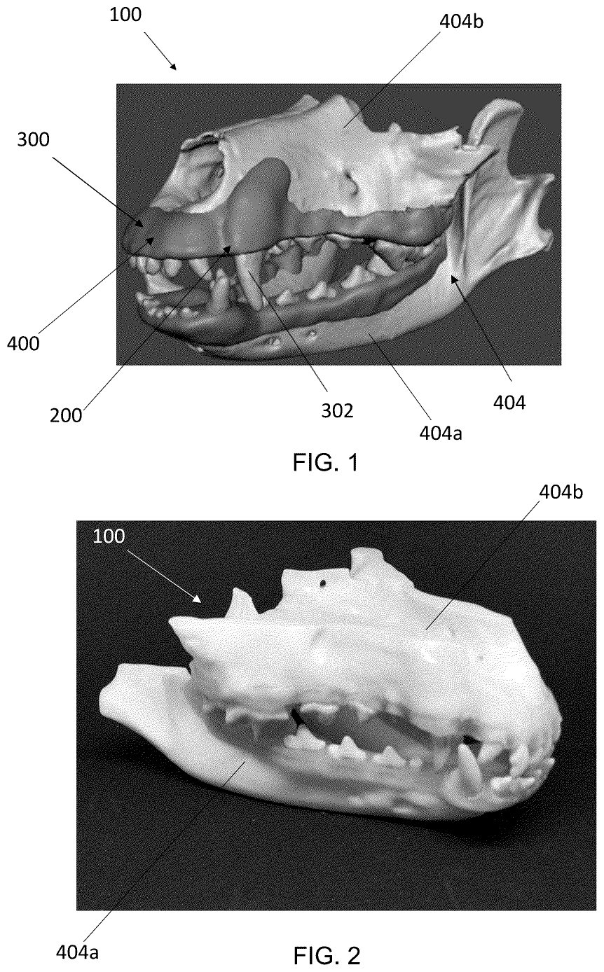

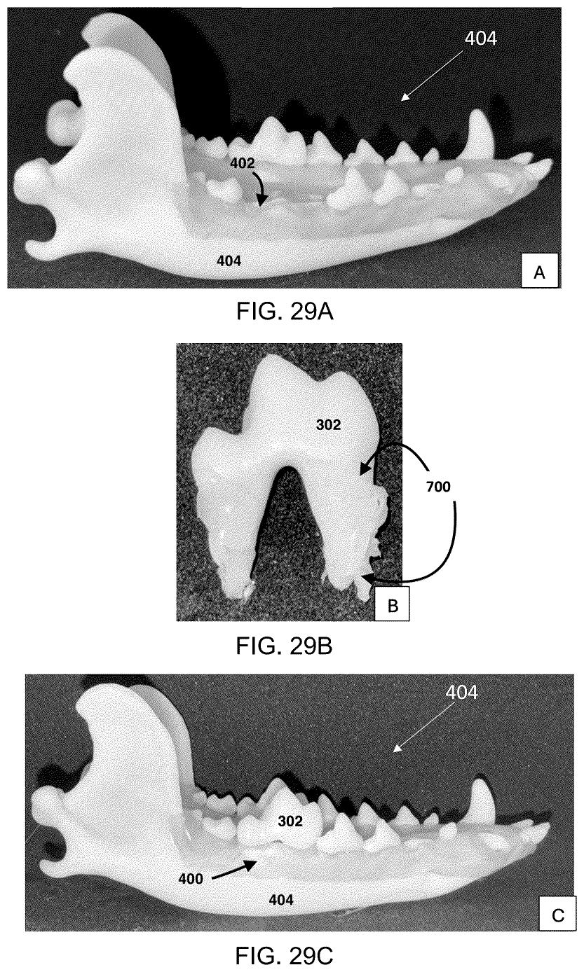

Embodiments of the present disclosure include a dental training model. FIG. 1 depicts a dental training model 100 according to an embodiment of the present disclosure. The dental training model 100 can be a veterinary dental training model, such as a model of an oral cavity of a canine. The dental training model 100 can include a jaw portion 404, a gingival portion 200, and/or a dental portion 300. The jaw portion 404 includes a bone socket portion 400 or an empty socket 402 (FIG. 29A). Further, the jaw portion 404 may be split into an upper jaw portion 404b and a lower jaw portion 404a. The dental portion 300 may include teeth or tooth-like structures 302.

Each jaw portion 404, gingival portion 200, and/or dental portion 300 of the dental training model 100 can be made of a distinct material. In one particular embodiment, each jaw portion 404, gingival portion 200, and/or dental portion 300 may be made of a distinct material such that each portion has a unique radiographic signature to duplicate normal dental elements in an X-ray image. The jaw portion 404 and/or gingival portion 200 may be made of any suitable material, such as a plastic material. According to some embodiments, the jaw portion 404 and gingival portion 200 are made of a single, unitary material. The unitary material may be fully or partially pliable and/or deformable. The unitary material may be a curable substance having one or more unique colors. In other embodiments, the jaw portion 404 and the gingival portion 200 can be made of distinct materials that are combined according to an additive process to form the dental training model 100. The jaw portion 404 can be made of a first material (e.g. a relatively rigid photopolymer material, such as VeroPureWhite) and the gingival portion 200 can be made of a second material (e.g. a translucent material, such as FLX9785, FLX9885, VeroClear, or AgilusClear). In embodiments of the present disclosure, the jaw portion 404 and the gingival portion 200 can form a single, monolithic structure despite the use of a plurality of distinct materials.

In order to provide realistic, detailed anatomical features, in embodiments of the present disclosure, the jaw portion 404 can be made with an additive manufacturing technique, such as three-dimensional (3D) printing; however, the dental training model 100 may be formed without 3D printing techniques. Maxilla and mandible components, including gingival sulci, may be fabricated either as a single, monolithic structure (e.g., produced in one continuous 3D printed structure, milling process, or other techniques), or as separate pieces assembled post-production. These components may leave empty tooth sockets 402 (FIG. 29A), which can receive individual teeth, such as tooth 302. The teeth 302 can be fixed into the tooth sockets 402, for example with a viscoelastic adherent. In one specific example, the teeth 302 may have a specific radiopacity so that they can be seen on a radiograph film, and allow for adequate contrast between jaw bone, gingival sulcus, and tooth roots. The teeth 302 can also be selected for placement in each tooth socket in a manner that emphasizes a particular disease pathology by being diminished in size. Alternatively, various molding techniques (such as injection molding) and/or materials can be used to create the dental training model 100 and/or its components.

The dental training model 100 can include custom disease pathology located within the jaw portion 404 of the model 100. In order to show the pathology, the dental training model 100 can be made of multiple materials, layers, and/or colors to show the contrast between anatomical features and pathology. In an embodiment, the dental training model 100 can include materials such as additive printed materials having various colors and opacities. Further, the dental training model 100 can be made of one or more materials for visible contrast between the jaw and gums visually and/or under radiographs. For example, those materials may include, VeroPureWhite, VeroMagenta, AgilusClear, VeroYellow, VeroCyan, VeroMagenta.

The dental training model 100 can include an upper jaw portion 404b and a lower jaw portion 404a that may contain a plurality of materials to allow better radiographic contrast or flexibility of the model 100. Moreover, each tooth socket 402 (FIG. 29A) can contain common tooth root pathology deemed radiolucent or radiopaque that is seen upon radiographic examination, such as the radiopaque elements described herein.

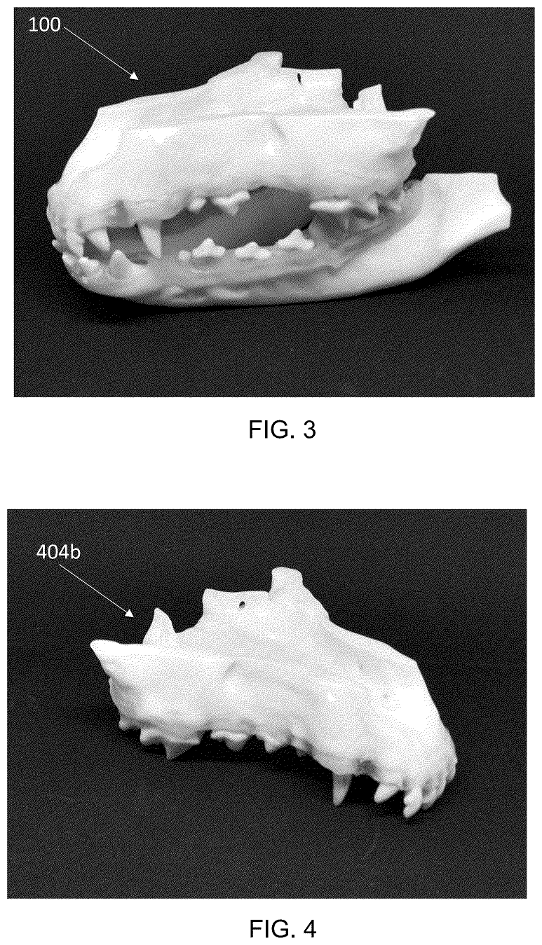

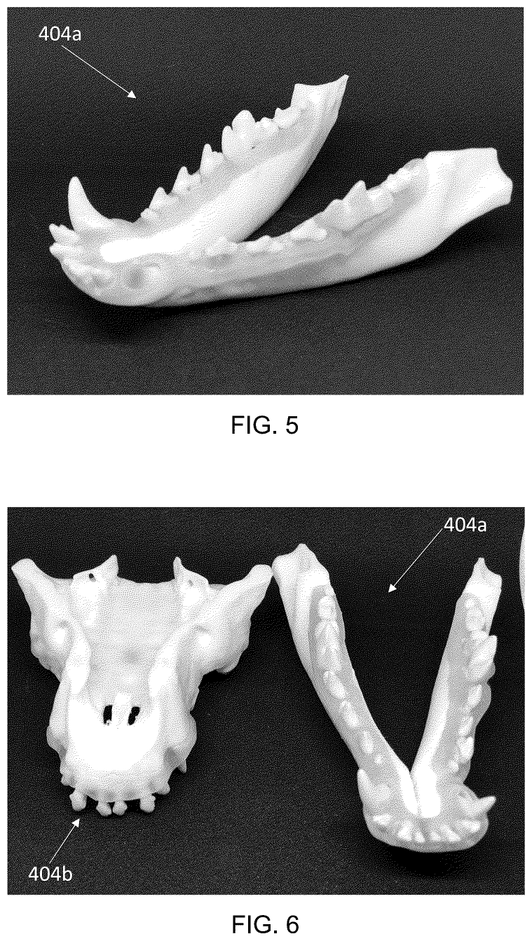

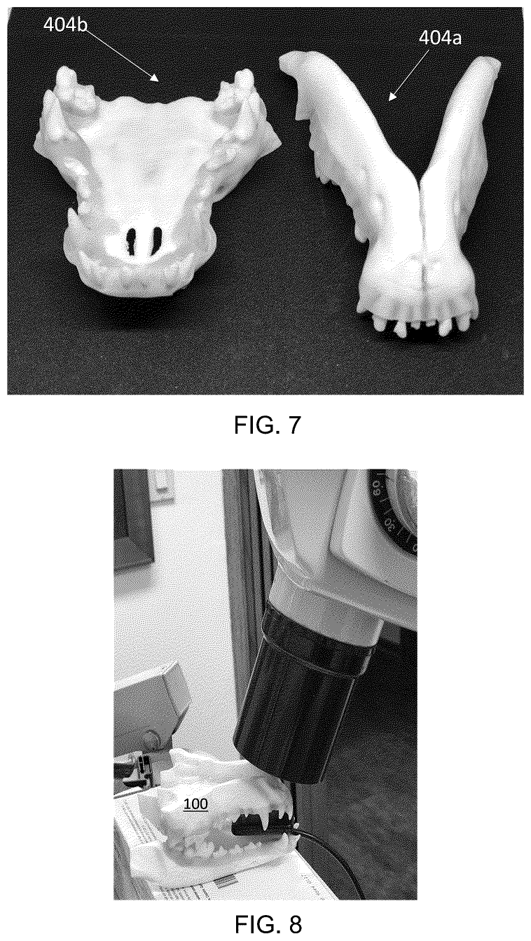

FIGS. 2-7 are photographic images of an embodiment of a dental training model 100, which may be split into an upper jaw portion 404b and a lower jaw portion 404a. In accordance with an embodiment of the present disclosure, the dental training model 100 can have a three-dimensional configuration and design that conveys anatomy seen in parts of the oral cavity and skull. For example, the dental training model 100 can contain anatomical foramen that are seen on skulls, for students to practice nerve blocks. Each individual tooth of the dental portion 300 may be set in a socket (bone socket 400 or empty socket 402) of the jaw portion 404 and gingival portion 200 (FIGS. 1, 29A, and 29C).

In embodiments, such as the embodiment shown in FIG. 1, the dental training model 100 can be configured such that the maxilla can articulate with the mandible and exhibit a prominent soft gingival sulcus for practicing periodontal probing. Moreover, the gingiva sulcus may be spaced apart from the cemento-enamel junction of the tooth to allow for realistic probing by a user. Moreover, the gingival portion 200 may be retractable relative to the jaw portion 404 and/or dental portion 300. For example, the gingival portion 200 may be made of a pliable and/or deformable material. The gingival sulci can be manipulated using a periodontal probe to examine an anatomical pocket (e.g. a 3 mm pocket). Probing the gingiva can allow the tooth to be examined circumferentially by a student. The dental training model 100 can include an orange-peel gingiva texture adhered superficially to the model. Retracting the gingival portion 200 may allow a user to see anatomical features and/or pathology not typically shown in known dental models.

Embodiments of the dental training model 100 can include examples of dental pathology to train students on recognizing diseases. For example, a user may practice identifying dento-alveolar pathology easily using embodiments of the present disclosure. The availability of a gingival sulcus with apparent periodontal disease can allow a user to observe common pathologies within the oral cavity of an animal. Although not shown in the figures, the dental training model 100 may include pulp chambers and multi-rooted teeth that can easily be differentiated on an X-ray image. The gingival portion 200 can allow for the dental training model 100 to contain segments of radiolucency in each socket, which may illustrate different tooth pathology.

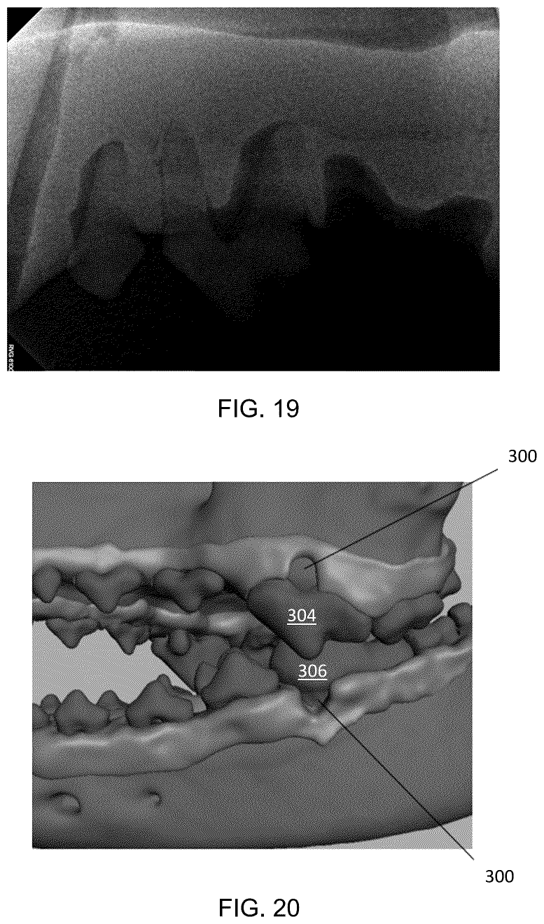

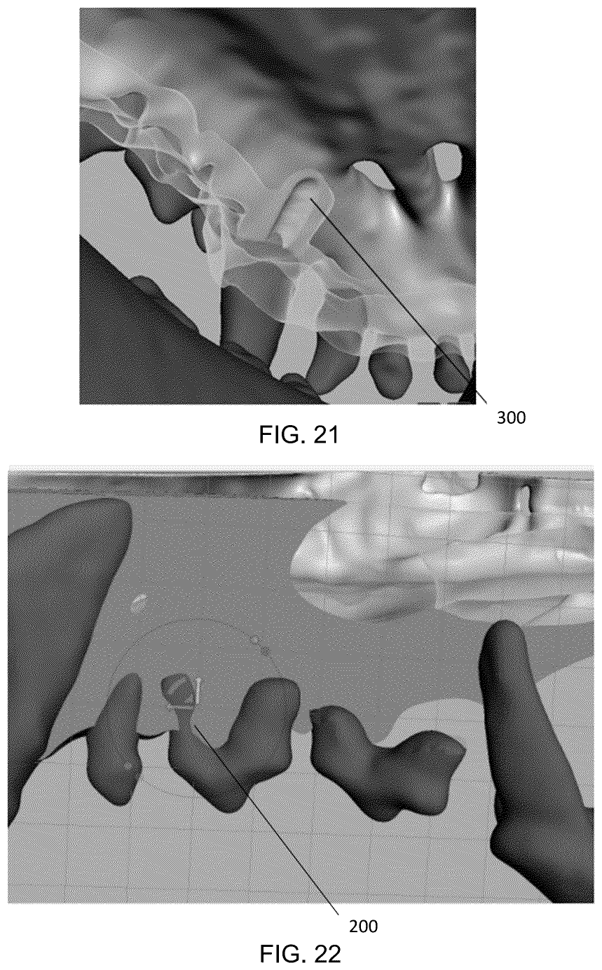

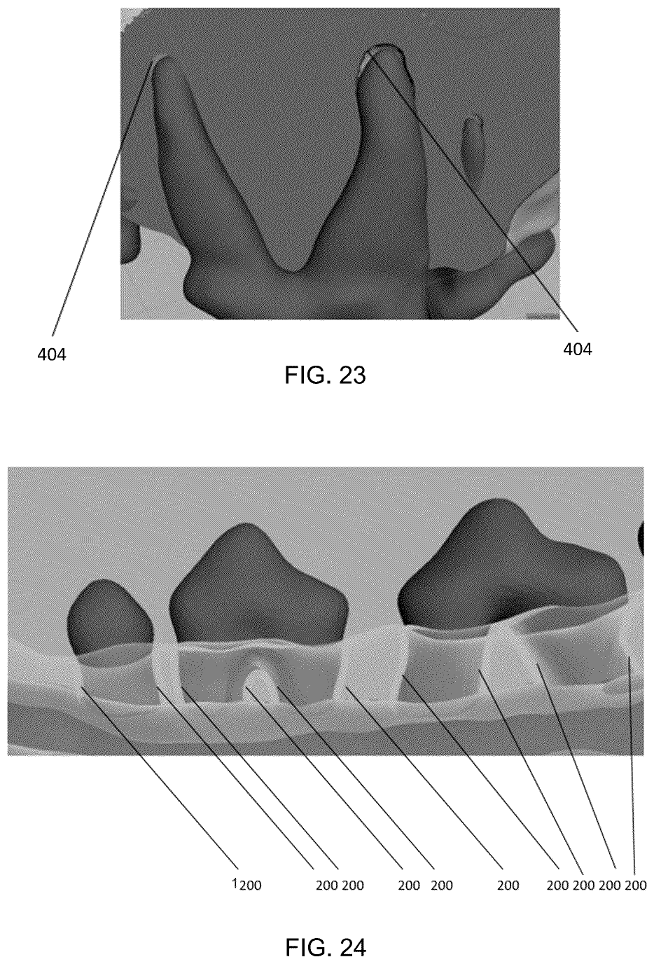

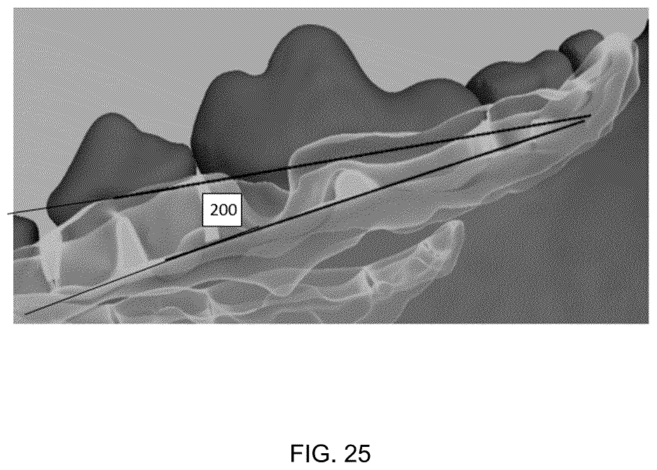

Specific additional tooth root pathology and various lesions may also be incorporated into the dental training model 100. As shown in FIG. 20, the gums have been recessed downwards in the dental portions 300 on both sides of tooth 304 and on the outer side of tooth 306. As shown, there is a trench (infrabony defect) in the jawbone behind tooth 304, over which the gum has been extended. FIG. 21 shows an infrabony defect in the dental portion 300 that allows the veterinarian to probe behind the tooth and into the gum. FIG. 22 shows tooth/bone resorption in the gingival portion 200 and has been introduced on teeth within the jaw. This is simulated by shortening the roots and adding bone to the places where they had formerly been. FIG. 23 shows periapical bone loss added to teeth within the jaw portion 404. FIG. 24 shows empty pockets of space beneath each root on the relevant teeth in the gingival portion 200, simulating vertical bone loss added to teeth. With reference to FIG. 24, the bone around these teeth is retracted downwardly at a uniform vertical distance. FIG. 25 shows horizontal bone loss added to teeth by retracting the bone in a similar fashion across those three teeth, but at an oblique angle, in the gingival portion 200. Moreover, upon radiographic examination, variations in periapical lesions and interradicular bone loss may be visible. Moreover, retraction of the gingival can reveal sub gingival calculus, root decay, or other pathology below the gingiva.

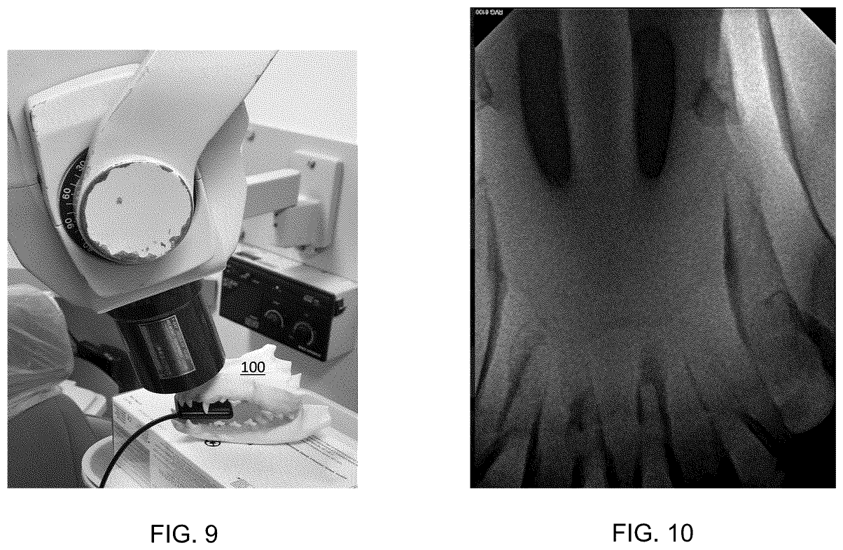

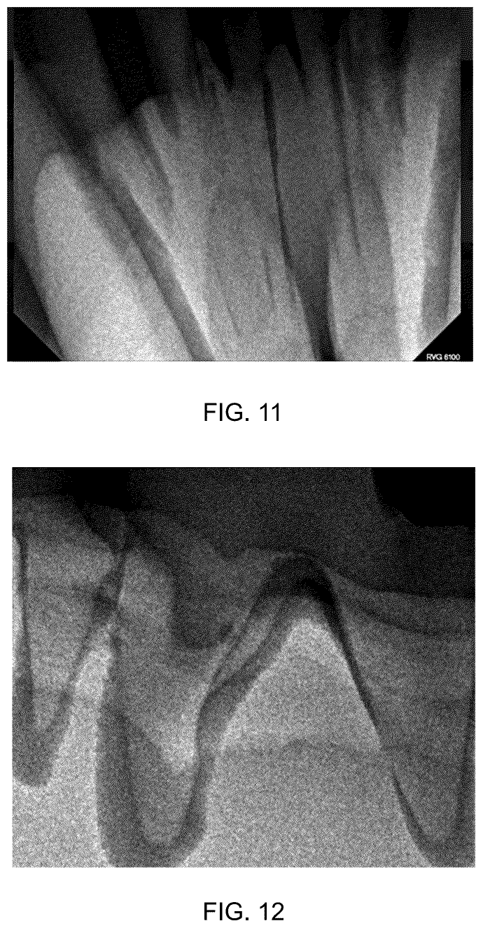

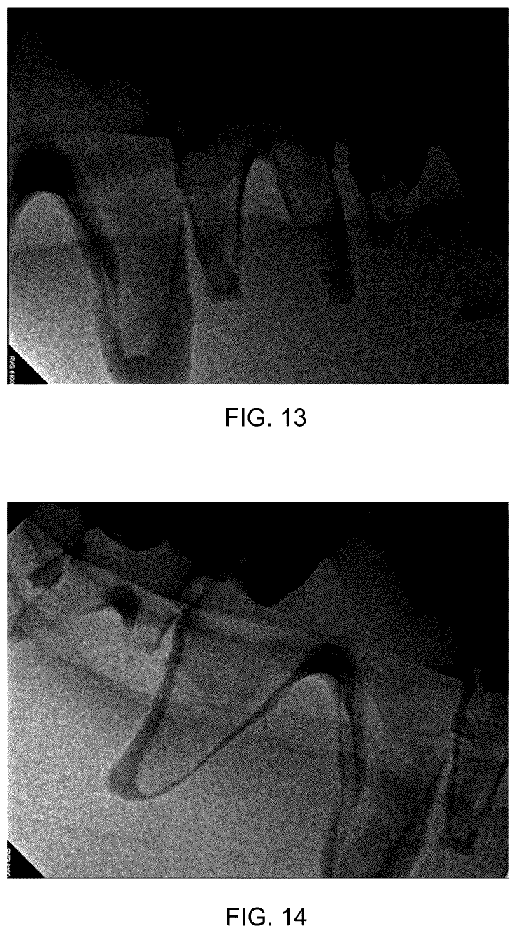

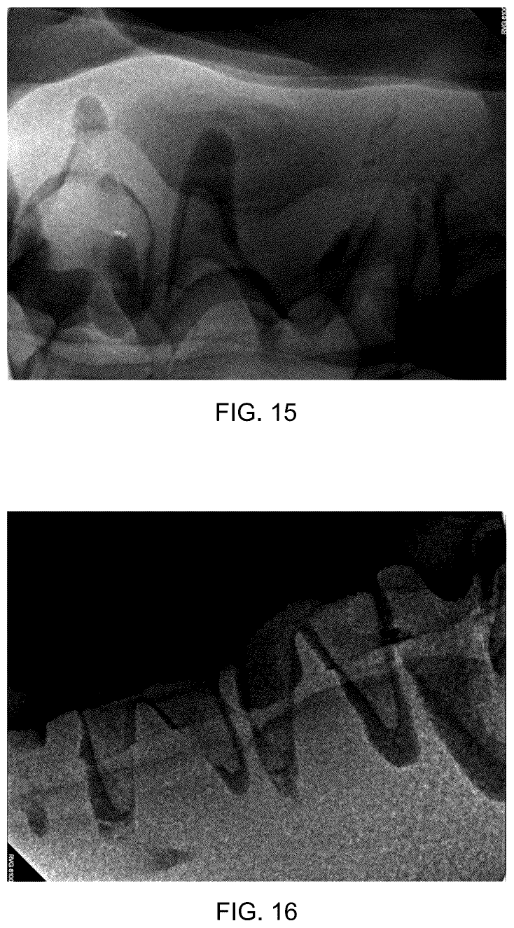

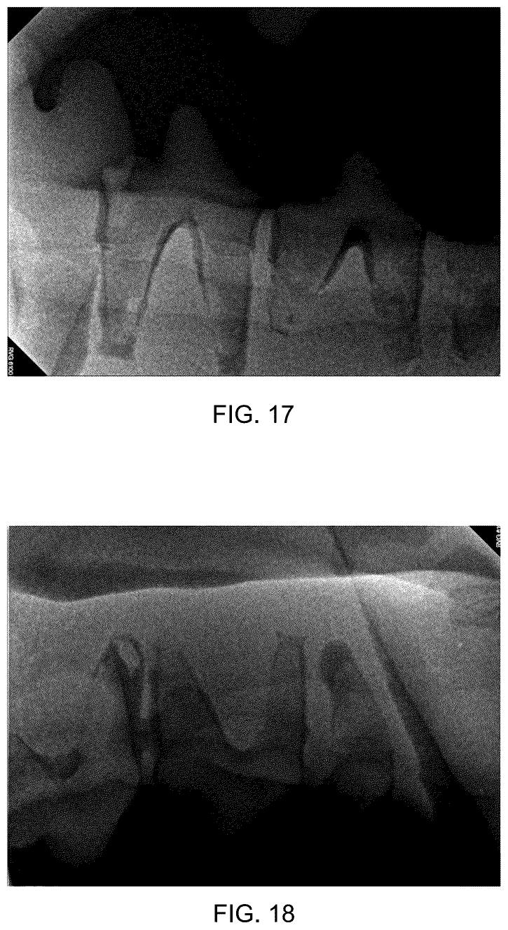

FIGS. 8 and 9 depict administration of X-rays to the dental training model 100. FIGS. 10-19 are X-ray images of embodiments of the dental training model 100, illustrating specific examples of pathology that can be used, for example, by a student to diagnose various types of pathology. FIG. 10 is a dorsoventral view showing bone vertical bone loss and periapical bone loss in the maxillary incisors. FIG. 11 is a dorsoventral view showing vertical bone loss and periapical bone loss in the mandibular incisors. FIG. 12 is a lateral view showing severe periapical bone loss, dental furcation exposure, and vertical bone loss. FIG. 13 is a lateral view showing severe periapical bone loss, vertical bone loss, and horizontal bone loss. FIGS. 14-18 are lateral views showing severe periapical bone loss, dental furcation exposure, tooth resorption, vertical bone loss, and horizontal bone loss, respectively. FIG. 9 shows a missing tooth, vertical bone loss, periapical bone loss, and horizontal bone loss.

Assembly of the dental training model 100 can include assembling the jaw portion 404. The jaw portions 404 and gingival portion 200, which may include gingival sulci can be made by additive manufacturing, such as 3D printing (e.g. a PolyJet 3D technology such as a Stratasys J750 machine), but other methods may be used. Suitable materials for the jaw portions 404 and gingival portion 200 may include VeroPureWhite and/or FLXA-MT-S85-DM, but other materials for fabrication are possible. Teeth 302 can be epoxy-based and manually glued into each appropriate tooth socket with a viscoelastic adherent 700 (FIG. 29B). The present disclosure is not limited to any particular animal or type, and can be for example a model cat, dog (large or small breed, brachycephalic, etc.), or horse. In one particular embodiment, the dental training model 100 can be of a canine having a length of 11.5 cm, a width of 8 cm, and a 3.5 cm height. The present disclosure is not limited to dental training models for animals. Embodiments of the dental training model may be used for human models.

The present disclosure further provides a synthetic connective tissue for use in a dental training model 100. In an embodiment, the synthetic connective tissue may include a viscoelastic adherent 700 configured to create a micromechanical bond between a tooth 302 and a socket (bone socket 400 and empty socket 402) in a jaw portion 404 of the dental training model 100, thereby simulating connective tissue (FIGS. 1 and 29A-29C).

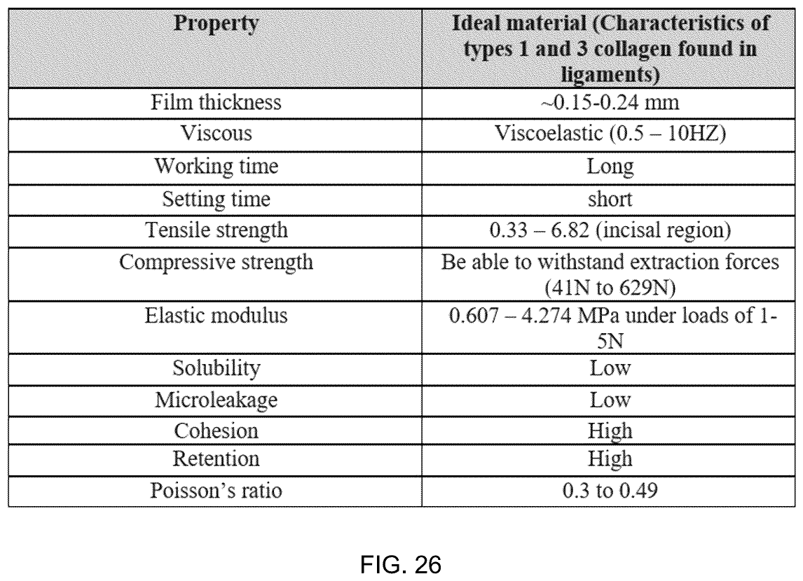

The table in FIG. 26 displays properties of embodiments of the viscoelastic adherent. These properties and values illustrate what the ideal material emulating a tendon and/or ligament can withstand and how it behaves under stressful situations and environmental conditions. These characteristics were selected to best represent types 1 and 3 collagen, often found in ligaments. The viscoelastic adherent may act as a ligament, such as a periodontal ligament in the oral cavity that connects a tooth to the alveolar bone in the socket. The properties of the viscoelastic adherent can be made using a variety of distinct materials, each simulating biomechanical features to best represent and ensure ligamentous stability. Embodiments of the present disclosure provide methods to synthesize and manufacture embodiments of the viscoelastic adherents including incorporating modified enzymes, developing transformations of chemical compounds, utilizing computer methods to target attractive molecules, and understanding the physical properties of each adherent produced.

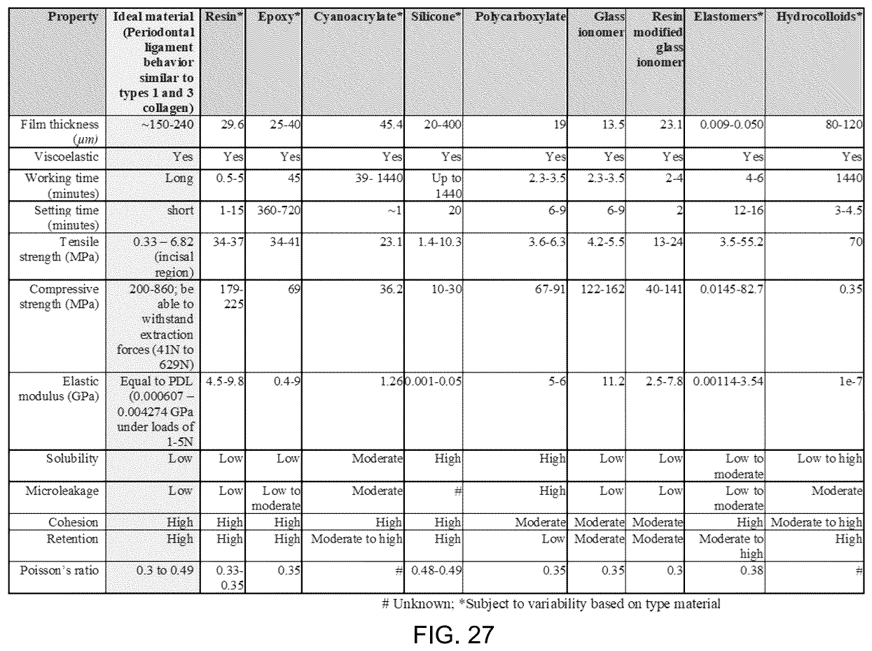

In an aspect of the present disclosure, the viscoelastic adherent may include one or more synthetic materials such as polymers, elastic compounds, and/or inelastic compounds. The table in FIG. 27 displays possible materials that may be used in the viscoelastic adherent having characteristics similar or dissimilar to the ideal material of the viscoelastic adherent used in the dental training model 100 (FIG. 1). The materials include one or more of a resin, epoxy, cyanoacrylate, silicone, polycarboxylate, glass ionomer, resin modified glass ionomer, elastomers, and/or hydrocolloids. In accordance with an embodiment of the present disclosure, the viscoelastic adherent can contain one or more (i.e. a combination) of these materials, if chemically compatible, or derivatives in accordance with the ideal material characteristics. For instance, the compressive strength of resin is within the range of the compressive strength of the ideal material; however, the elastic modulus of the resin is higher compared to the ideal adherent. For example, cyanoacrylate has a lower elastic modulus than resin, but a higher elastic modulus compared to the ideal material. Silicone has a tensile strength within the means of the ideal viscoelastic adherent, but a lower compressive strength compared to the ideal material. Polycarboxylate contains a lower compressive strength, higher solubility, and higher microleakage compared to the ideal material, yet has a similar tensile strength. Glass ionomer has a lower compressive strength compared to the ideal material but similar solubility and microleakage values. Resin-modified glass ionomers have lower compressive and tensile strengths compared to the ideal material. Elastomers have an almost equitable elastic modulus value compared to the ideal material but have a small film thickness. Hydrocolloids have a similar elastic modulus, but low compressive strength compared to the ideal material. The ideal viscoelastic adherent may contain a multitude of characteristics from each compound that accurately depict a real-life ligament. Alternatives to these materials, such as silica, alumina, magnesia, styrene block copolymers, polyethylene, other water-based acrylics, and porcelain cements, may also help provide the ideal viscoelastic adherent. Embodiments of the viscoelastic adherent may be in either a liquid and/or a semisolid form, which hardens and sets. Ratios of each material are subject to change, depending on the types of chemicals used to achieve the desired outcome of the viscoelastic adherent.

For example, in embodiments of the present disclosure, the viscoelastic adherent may include a first part having a cyanoacrylate derivative and a second part having a liquid configured to activate the cyanoacrylate derivative and initiate the micromechanical bond. Further, embodiments of the viscoelastic adherent may include a cyanoacrylate monomer derivative of methyl cyanoacrylate and one or more of a copolymer, a silicone, and/or a resin. Even further, the viscoelastic adherent may include a free radical curable component formed of a cyanoacrylate compound.

As shown in the table in FIG. 27, different materials may have different solubility ranging from high to low.

As shown in the table in FIG. 27, different materials may have different microleakage rates ranging from high to low. Embodiments of high-performance viscoelastic adherents may have zero or minimal microleakage. For example, embodiments may have a leakage threshold of less than 0.1 mm of penetration or less than 0.03 μL/min leakage rate.

As shown in the table in FIG. 27, different materials may have different cohesion values ranging from high to low. For cyanoacrylate, the cohesion value might range from 20 MPa to 60 MPa, depending on formulation and curing conditions. For silicone elastomers, the cohesion value might range from 2 MPa to 10 MPa, reflecting their rubber-like elasticity and lower stiffness compared to more rigid materials. For epoxy resins, the cohesion values tend to be much higher, often in the range of 40 MPa to 100 MPa depending on the specific resin type and the curing process used. Embodiments of the viscoelastic adherent may have a cohesion value of the viscoelastic material may be enough to withstand forces in the range of 30 MPa to 100 MPa.

As shown in the table in FIG. 27, different materials may have different retention values ranging from low to high. Cyanoacrylate adhesives typically show a bond strength of 15 MPa to 30 MPa for metal-to-metal or metal-to-plastic bonds, with peak performance often around 20-25 MPa. Silicone adhesives generally have lower bond strengths, ranging from 1 MPa to 3 MPa due to their flexible nature. However, their strength in sealing applications can still be considerable in environments involving thermal cycling and stress relaxation. Epoxy resins often exhibit very high bond strengths, with adhesion values ranging from 30 MPa to 80 MPa in metal or composite bonding, especially when using structural adhesives that have been cured optimally. Embodiments of the viscoelastic adherents may exceed 20 MPa, ideally 30-50 MPa for metal-to-metal or composite-to-composite bonding. Further, a lower bond strength is acceptable to allow for controlled removability, with values typically in the 5 MPa to 15 MPa range.

### Combination of Materials as Shown in FIG. 27

Embodiments of the present disclosure may include viscoelastic adherents made of a combination of cyanoacrylate and silicone. The ratio of the components may vary depending on the purpose of the viscoelastic adherents, such as the characteristic it is meant to simulate.

Embodiments of the present disclosure may also include viscoelastic adherents made of a combination of polycarboxylates and epoxy resins. The ratio of the components may vary depending on the purpose of the viscoelastic adherents, such as the characteristic it is meant to simulate.

Embodiments of the present disclosure may also include viscoelastic adherents made of a combination of elastomers and hydrocolloids. The ratio of the components may vary depending on the purpose of the viscoelastic adherents, such as the characteristic it is meant to simulate.

Embodiments of the present disclosure may also include viscoelastic adherents made of a combination of cyanoacrylate, epoxy resin, and elastomer. The ratio of the components may vary depending on the purpose of the viscoelastic adherents, such as the characteristic it is meant to simulate.

Embodiments of the present disclosure may also include viscoelastic adherents made of a combination of silicones and urethane elastomers. The ratio of the components may vary depending on the purpose of the viscoelastic adherents, such as the characteristic it is meant to simulate.

Embodiments of the present disclosure further include one or more radiopaque elements, such as barium sulphate, disposed within the viscoelastic adherent. Further, the tooth 302 and/or the jaw 404 of the dental training model 100 (FIG. 1) may also include one or more radiopaque elements. Different radiopaque elements may have different radiodensities and may display differently under radiographic images. In an embodiment, the radiopaque elements of the tooth 302 and/or the jaw 404 may differ in radiodensity from the radiopaque elements disposed within the viscoelastic adherent.

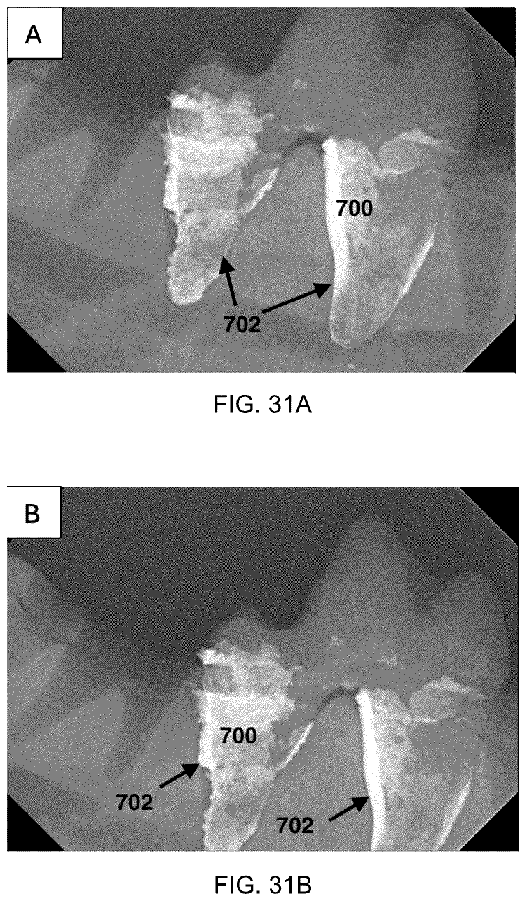

Embodiments of the dental training model 100 disclosed herein may be used for the purpose of practicing surgical skills, such as dental extractions. In an embodiment, a viscoelastic adherent 700 may be used between two surfaces in the dental training model 100 (FIGS. 1 and 29A-29C). The viscoelastic adherent 700 used may resemble attributes of either lifelike tendons or ligaments. Using an embodiment of the dental training model 100, the user may add the viscoelastic adherent 700 on two surfaces of the dental training model 100 that are intended to be separated utilizing instruments (FIGS. 1, 29A-29C, and 30A-30B). The user may take a radiograph to appropriately delineate the viscoelastic adherent 700 from the underlying surfaces (FIGS. 31A-31B). Due to the radiopaque elements 702 included in the viscoelastic adherent 700, it will illuminate and pinpoint the user into determining where exactly the viscoelastic adherent 700 is located. The user may then use the appropriate instrument to carefully apply force and torque between the two surfaces on the dental training model 100. The user may then appreciate separation between the two surfaces after prolonged forces are enacted upon. The viscoelastic adherent 700 will gradually stretch until either surface yields or forces there to be separation between the two objects that were connected by cohesive forces. The user can then inspect both surfaces to ensure no iatrogenic or self-inflicted damage has occurred.

Embodiments of the dental training model utilizing the viscoelastic adherent provide biomechanical characteristics that allows the user to have a simulated surgical experience and experience tactile sensitivity that they would otherwise feel on a real human patient.

The following examples are presented to illustrate the present disclosure. They are not intended to be limiting in any matter.

### EXAMPLE 1

This example provides a description of an embodiment of the dental training model used for practicing surgical skills, including the viscoelastic adherent and the one or more radiopaque elements, as described herein.

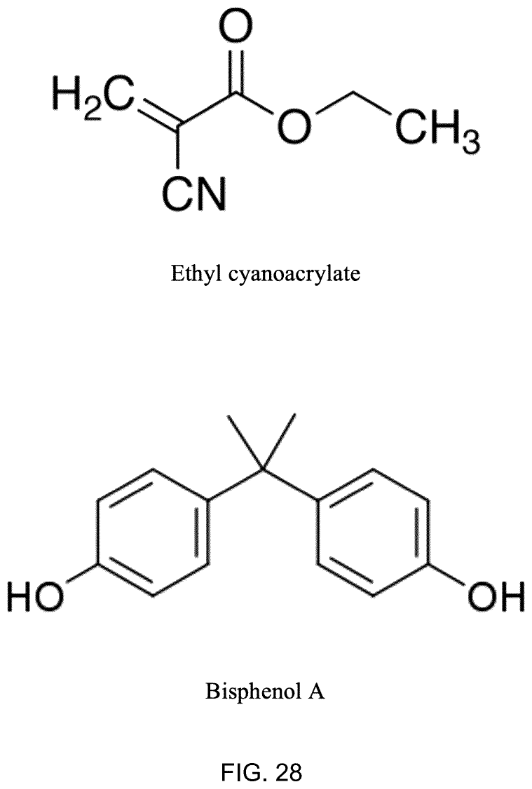

FIG. 28 displays a flowable composite containing bisphenol A combined with cyanoacrylate, yielding an embodiment of a viscoelastic adherent 700. As shown in FIGS. 29A-29C, the viscoelastic adherent 700 was successfully applied to the tooth 302 (FIG. 29B), which adhered to the alveolar bone socket 400 (FIGS. 29A and 29C). In the oral cavity, each tooth is adhered to the alveolar bone socket by a ligament, termed the periodontal ligament. The periodontal ligament includes a dense network of connective tissue, involving a variety of collagen and other cell lineages. The images display an empty socket 402 (FIG. 29A), the tooth with a simulated viscoelastic adherent 700 (FIG. 29B), and the incorporation of the tooth into the empty socket 402 of a canine jaw 404 (FIG. 29C).

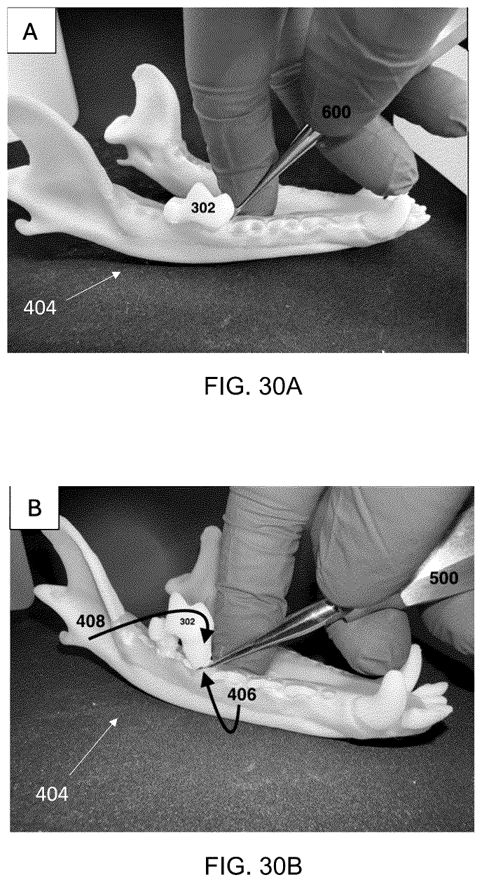

In this example, the viscoelastic adherent provided similar structural stability and integrity to an actual periodontal ligament. For example, the tooth did not detach unless the tooth was surgically extracted using dental instruments, such as dental elevators 500 (FIGS. 30A-30B). Using leverage 600 with dental instruments, the user was able to appreciate the separation 406 and extraction 408 of the tooth from the alveolar bone socket. By simulating a realistic tooth extraction experience, the user could see features of improved surgical training models that are not typically seen.

FIG. 31A-31B depicts the administration of X-rays to the viscoelastic adherent 700. In this example, the viscoelastic adherent 700 contained barium sulfate, enabling bright white (radiopaque element 702) features of the ligament. The outline of the viscoelastic adherent 700 on the radiographic film may serve to provide landmarks and pinpoint where the bone is in relation to the ligament, providing the user with pertinent information prior to advanced surgery. In the example of extracting a large molar tooth, the unique radiographic feature in the viscoelastic adherent may inform the user how much depth and space they have before inserting a sharp dental instrument (i.e., dental elevator) into the periodontal ligament. The viscoelastic adherent, with this ability to be appreciated on X-rays, is visible as a bright white feature of the radiopaque elements 702.

Although the present disclosure has been described with respect to one or more embodiments, it will be understood that other embodiments of the present disclosure may be made without departing from the spirit and scope of the present disclosure. The following are sample claims intended to further illustrate the disclosure and not to limit it. The design and functionality described in this application are intended to be exemplary in nature and are not intended to limit the instant disclosure in any way. Certain implementations of the present disclosure are not subject to limitations. This disclosure is intended to cover various modifications and equivalent arrangements included within the scope of the appended claims.

1. A dental training model, comprising:
a viscoelastic adherent configured to produce a micromechanical bond between a tooth and a socket in a jaw of the dental training model, thereby simulating connective tissue; and
one or more radiopaque elements disposed within the viscoelastic adherent.

2. The dental training model of claim 1, wherein the connective tissue comprises a tendon or a ligament.

3. The dental training model of claim 1, wherein the viscoelastic adherent comprises one or more of the following:
a resin;
epoxy;
cyanoacrylate;
silicone;
polycarboxylate;
glass ionomer;
resin modified glass ionomer;
elastomers; and
hydrocolloids.

4. The dental training model of claim 1, wherein the viscoelastic adherent comprises:
a first part comprising a cyanoacrylate derivative; and
a second part comprising a liquid configured to activate the cyanoacrylate derivative and initiate the micromechanical bond.

5. The dental training model of claim 1, wherein the viscoelastic adherent comprises:
a cyanoacrylate monomer derivative of methyl cyanoacrylate; and
one or more of the following: a copolymer, a silicone, and a resin.

6. The dental training model of claim 1, wherein the viscoelastic adherent comprises a free radical curable component formed of a cyanoacrylate compound.

7. The dental training model of claim 1, wherein the tooth and/or the jaw include one or more radiopaque elements.

8. The dental training model of claim 7, wherein the one or more radiopaque elements of the tooth and/or the jaw differ in radiodensity from the one or more radiopaque elements disposed within the viscoelastic adherent.

9. The dental training model of claim 1, wherein the one or more radiopaque elements comprise barium sulphate.

10. A synthetic connective tissue for use in a dental training model, the synthetic connective tissue comprising:
a viscoelastic adherent configured to create a micromechanical bond between a tooth and a socket in a jaw of the dental training model, thereby simulating connective tissue; and
one or more radiopaque elements disposed within the viscoelastic adherent.

11. The synthetic connective tissue of claim 10, wherein the connective tissue comprises a tendon or a ligament.

12. The synthetic connective tissue of claim 10, wherein the viscoelastic adherent comprises one or more of the following:
a resin;
epoxy;
cyanoacrylate;
silicone;
polycarboxylate;
glass ionomer;
resin modified glass ionomer;
elastomers; and
hydrocolloids.

13. The synthetic connective tissue of claim 10, wherein the viscoelastic adherent comprises:
a first part comprising a cyanoacrylate derivative; and
a second part comprising a liquid configured to activate the cyanoacrylate derivative and initiate the micromechanical bond.

14. The synthetic connective tissue of claim 10, wherein the viscoelastic adherent comprises:
a cyanoacrylate monomer derivative of methyl cyanoacrylate; and
one or more of the following: a copolymer, a silicone, and a resin.

15. The synthetic connective tissue of claim 10, wherein the viscoelastic adherent comprises a free radical curable component formed of a cyanoacrylate compound.

16. A method of manufacturing a dental training model, comprising:
providing a viscoelastic adherent with one or more radiopaque elements disposed within the viscoelastic adherent; and
disposing the viscoelastic adherent between a tooth and a socket in a jaw of the dental training model to produce a micromechanical bond, thereby simulating connective tissue.

17. The method of manufacturing of claim 16, wherein the viscoelastic adherent comprises one or more of the following:
a resin;
epoxy;
cyanoacrylate;
silicone;
polycarboxylate;
glass ionomer;
resin modified glass ionomer;
elastomers; and
hydrocolloids.

18. The method of manufacturing of claim 17, wherein the tooth and/or the jaw include one or more radiopaque elements.

19. The method of manufacturing of claim 18, where the one or more radiopaque elements of the tooth and/or the jaw differ in radiodensity from the one or more radiopaque elements disposed within the viscoelastic adherent.
